(19) United States
(12) Patent Application Publication
(10) Pub. No.: US 2021/0327275 A1
(43) Pub. Date: Oct. 21, 2021

(54) A FIRST ON-BOARD CONTROL UNIT AND A METHOD FOR OPERATING A FIRST ON-BOARD CONTROL UNIT

(71) Applicant: Robert Bosch GmbH, Stuttgart (DE)

(72) Inventors: Klaus Sambale, Oberhausen (DE); Frank Hofmann, Hildesheim (DE); Nadia Brahmi, Hildesheim (DE)

(21) Appl. No.: 17/272,566

(22) PCT Filed: Aug. 26, 2019
(86) PCT No.: PCT/EP2019/072675

§ 371 Date: Mar. 1, 2021

(30) Foreign Application Priority Data
Sep. 4, 2018 (DE) 10 2018 215 028.1

(51) Int. Cl. G08G 1/16; H04W 4/46; H04W 24/08; B60T 8/171

(52) U.S. Cl. CPC G08G 1/162; H04W 4/46; B60T 2210/00; H04W 24/08; B60T 8/171; G08G 1/166

(57) ABSTRACT

A method is provided for operating a first on-board control unit for a first motor vehicle. The method includes: receiving a first control message, which includes at least one piece of driving condition information, originating from a second on-board control unit of a second motor vehicle, ascertaining a first point in time for initiating a response of the first motor vehicle as a function of the first control message, selecting the first point in time as the valid point in time, and then ascertaining a signal for initiating the response of the first motor vehicle if, up to the valid point in time, no further control message originating from the second on-board control unit is successfully received.

### FIELD

The present invention relates to a first on-board control unit and to a method for operating a first on-board control unit.

### SUMMARY

According to a first aspect of the present invention, a first on-board control unit for a first motor vehicle is provided. In accordance with an example embodiment of the present invention, the first on-board control unit includes at least one processor, at least one memory including computer program code, at least one communication module and at least one antenna, the computer program code being configured in such a way that it, including the at least one processor, the at least one communication module and the at least one antenna, ensures that the first on-board control unit receives a first control message, which includes at least one piece of driving condition information, originating from a second on-board control unit of a second motor vehicle preceding, in particular immediately the first motor vehicle, and ascertains a first point in time for initiating a response of the first motor vehicle, for example a brake application, in particular an emergency brake application
as a function of the first control message, selects the first point in time as the valid point in time, and then ascertains a signal for initiating the response of the first motor vehicle if, up to the valid point in time, no further control message originating from the second on-board control unit is successfully received.

The first control unit advantageously utilizes only the information of the respective preceding motor vehicle for determining the point in time or whether a response is to be initiated. This ensures that as soon as the first motor vehicle no longer receives any control messages and therefore also no longer transmits any, the following motor vehicle also initiates a response. This ensures that beginning with the motor vehicle within the platoon in which an error occurs, all following motor vehicles also carry out the response and thus ensure the safety of the platoon. As a result, control messages that are used for maintaining and coordinating the group are utilized to keep the group of motor vehicle in a safe state. Should the valid point in time be reached—i.e., subsequent further control messages fail to appear due to a disruption of the radio transmission or to a disruption of the control units involved, the, for example, brake application of the first motor vehicle is initiated, which brings the first motor vehicle safely to a standstill without rear-ending the preceding vehicle. The provided mechanism may of course also be used for an intentional brake application, whereby the stream of control messages is interrupted in a targeted manner once a hazardous situation has been reliably identified. In addition, the provided mechanism is technically easy to implement. As a result, potentially hazardous situations, such as the appearance of an obstacle ahead of the preceding vehicle of the group of motor vehicles or a disruption of the communication may be resolved in a safe manner within the group of motor vehicles.

In another driving situation, a reduction of the engine power is carried out in response to the absence of the control messages originating from the second motor vehicle, so that the first motor vehicle performs a planned evasive maneuver—perhaps already in advance in case of emergency—depending on the traffic situation, in order to avoid a corresponding emergency brake application or at least, depending on the necessity of the situation, to come to a standstill more comfortable for the driver with reduced braking power.

In accordance with an example embodiment of the present invention, the first on-board control unit receives a second control message originating from the second on-board control unit of the second motor vehicle immediately preceding the first motor vehicle temporally before the occurrence of the valid point in time, ascertains a second point in time for initiating the response of the first motor vehicle as a function of the second control message, the second point in time lying further in the future compared to the valid point in time, and selects the second point in time as the valid point in time. When temporally successive control messages are received, the valid point in time is advantageously pushed into the future, whereby the response, in particular, a brake application of the first motor vehicle or the reduction of the engine power of the first motor vehicle, is suppressed.

In accordance with an example embodiment of the present invention, the first on-board control unit ascertains a safety time period, ascertains the respective point in time as a function of the ascertained safety time period, and adapts a safety distance between the first motor vehicle and the second motor vehicle as a function of the safety time period. The point in time and the safety distance are thus advantageously adapted to one another in such a way that, for example, an emergency brake application without rear-ending is possible. Both aforementioned variables are advantageously derived from the ascertained safety time period, whereby on the one hand a simplification of the provided mechanism is involved and on the other hand the operating safety of the motor vehicle is increased.

In accordance with an example embodiment of the present invention, the respective control message includes an indication for a generation point in time of the control message, and the first control unit ascertains the respective point in time as a function of the safety time period and as a function of the respective generation point in time of the control message. The first control unit advantageously derives the point in time from the actual generation point in time of the received control message. As a result, it is ensured that the safety point in time starts with the generation point in time. The safety time period may, for example, be selected to be shorter as a result.

In accordance with an example embodiment of the present invention, the first control unit estimates a generation point in time of the respective control message as a function of a reception point in time of the respective control message, and ascertains the respective point in time as a function of the safety time period and as a function of the estimated generation point in time of the respective control messages. An ascertainment and a transport of the generation point in time is advantageously omitted, which saves resources on the part of the second control unit and radio resources. Moreover, a time synchronization of the control units is not necessary and a corresponding time module may be omitted.

In accordance with an example embodiment of the present invention, the first on-board control unit ascertains a quality of service, QoS, of the control messages received by the second control unit, and ascertains the safety time period as a function of the ascertained QoS. The control unit is advantageously adapted to the congestion level on the radio channel used by taking the quality of service of the control messages received by the second control unit into account. An increased congestion level of the radio channel results, for example, in a longer safety time period and consequently in a greater safety distance between the motor vehicles. An increased congestion level is of course not the only cause for a deterioration of the quality of service/service quality. Unfavorable propagation conditions or willful disruptions of the radio channel (“jamming”) may also result in an increased packet error rate.

In accordance with an example embodiment of the present invention, the safety time period is greater than a period duration of a transmitting and/or receiving frequency of the control messages originating from the second control unit. As a result of this, the not unnecessarily planned response is also triggered at the valid point in time when individual control messages are not received.

In accordance with an example embodiment of the present invention, up to the occurrence of the valid point in time, the first on-board control unit sends a further number of control messages, each of which includes at least one piece of driving condition information, in the direction of a third on-board control unit of a third motor vehicle, and after the occurrence of the valid point in time sends no further control messages in the direction of the third on-board control unit. A stream of the control messages to the third control unit, which also influences its safety distance of the third motor vehicle to the first motor vehicle, is also promptly interrupted, so that the third control unit is equally also able to promptly initiate the response such as, for example, an emergency brake application, in order to bring the third motor vehicle to a standstill without rear-ending the first motor vehicle.

One further aspect of the present invention relates to a motor vehicle including the first on-board control unit according to one of the preceding aspects and including a braking system, the first on-board control unit transmitting the signal for initiating a brake application of the first motor vehicle to the braking system.

A third aspect of the present invention relates to a method for operating a first on-board control unit for a first motor vehicle. In accordance with an example embodiment of the present invention, the method includes: receiving a first control message, which includes at least one piece of driving condition information, originating from a second on-board control unit of a second motor vehicle traveling, in particular, immediately or directly ahead of the first motor vehicle, ascertaining a first point in time for initiating a response of the first motor vehicle as a function of the first control message, selecting the first point in time as the valid point in time, and ascertaining a signal for initiating the response of the first motor vehicle if, up to the valid point in time, no further control message originating from the second on-board control unit is successfully received.

### BRIEF DESCRIPTION OF THE DRAWINGS

Further features and advantages are derivable from the description below and from the figures.

FIG. 1 shows a traffic situation in a schematic, perspective view, in accordance with an example embodiment of the present invention.

FIG. 2 schematically shows a flowchart, in accordance with an example embodiment of the present invention.

FIG. 3 shows a control message in a schematic view, in accordance with an example embodiment of the present invention.

FIG. 4 schematically shows a sequence diagram for operating a radio communication network, in accordance with an example embodiment of the present invention.

FIG. 5 schematically shows a block diagram, in accordance with an example embodiment of the present invention.

### DETAILED DESCRIPTION OF EXAMPLE EMBODIMENTS

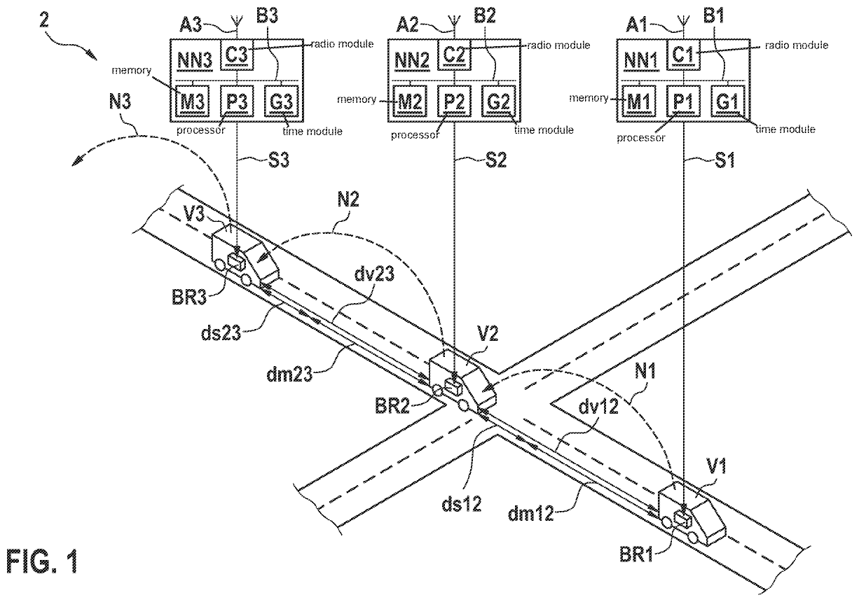

FIG. 1 schematically shows a perspective view of an exemplary traffic situation. Each motor vehicle V1, V2, V3 includes an on-board control unit NN1, NN2, NN3, which together form a radio communication network 2. Respective motor vehicle V1, V2, V3 is, in particular, a truck or a truck and trailer or semitrailer truck.

Each of control units NN1, NN2, NN3 includes a data bus B1, B2, B3, which interconnects at least one processor P1, P1, P3, one memory M1, M2, M3 and one radio module C1, C2, C3. At least one antenna A1, A2, A3 is connected to radio module C1, C2, C3. Respective radio module C1, C2, C3 is configured to transmit and receive radio signals according to ad hoc radio communication network 2 via antenna A1, A2, A3. A computer program in the form of a computer program product is stored on memory M1, M2, M3.

The computer program is designed to carry out the method steps outlined in this description, in particular, with the aid of the at least one processor P1, P2, P3, of the at least one memory M1, M2, M3 and of the at least one radio module C1, C2, C3, and to communicate with further control units via the at least one antenna A1, A2, A3. Alternatively or in addition, processors P1, P2, P3 are implemented as ASICs in order to carry out the described method steps. Respective control unit NN1, NN2, NN3 includes a time module G1, G2, G3, with the aid of which respective control unit NN1, NN2, NN3 synchronizes its internal clock to a global time. Time module G1, G2, G3 is, for example, a GPS module (GPS: Global Positioning System). This internal clock synchronized to the global time is utilized to coordinate the actions of on-board control units NN1 through NN3. Respective motor vehicle V1, V2, V3 includes a braking system BR1, BR2, BR3. Respective control unit NN1, NN2, NN3 initiates a response of motor vehicle V1, V2, V3 such as, for example, a brake application, in particular an emergency brake application and/or a reduction of the engine power, with the aid of a signal S1, S2, S3, signal S1, S2, S3 being transmitted to respective braking system BR1, BR2, BR3.

Respective control unit NN1, NN2, NN3 in one exemplary embodiment is made up of multiple individual components—such as, for example, a radio communication network terminal and a control unit, which in turn include at least one processor, one memory, one data bus and at least one communication interface. The terminal receives and transmits control messages, for example, the pieces of information contained in the control messages being processed by the at least one control unit, the at least one control unit ascertaining signal S1.

Radio communication network 2 provides, for example, at least one ad hoc radio channel in the form of radio resources or radio operation means. Each of control units NN1, NN2, NN3 is configured, for example, according to the Standard IEEE 802.11p, in particular, IEEE 802.11p-2010 of Jul. 15, 2010, which is incorporated by reference in this description. The IEEE 802.11p PHY and MAC functions provide services for protocols of the upper layer for dedicated short range communication, DSRC in the U.S. and for cooperative ITS, C-ITS, in Europe. Control units NN1, NN2, NN3 communicate directly with one another via the ad hoc radio channel in the non-licensed frequency range. The ad hoc radio channel is accessed by radio modules C1, C2, C3 with the aid of a CSMA/CA protocol (Carrier Sense Multiple Access/Collision Avoidance). The ad hoc radio channel and radio communication network 2 are specified, for example, by the IEEE Standard “802.11p-2010—IEEE Standard for Information Technology—Local and Metropolitan Area Networks—” Specific Part 11: Wireless LAN Medium Access Control (MAC) and Physical Layer (PHY) Specifications Amendment 6: Wireless Access in Vehicular Environments,” which is incorporated by reference. IEEE 802.11p is a standard for expanding the WLAN Standard IEEE 802.11. The aim of IEEE 802.11p is to establish radio technology in passenger vehicles and to provide a reliable interface for Intelligent Transport Systems (ITS) applications. IEEE 802.11p is also the basis for Dedicated Short Range Communication (DSRC) in the range from 5.85 GHZ through 5.925 GHz. On-board control units NN1, NN2, NN3 alternatively form a communication network according to the LTE-V Standard or another standard. In order to access the ad hoc radio channel, control units NN1, NN2, NN3 apply, for example, a Listen-Before-Talk method. The LBT includes a back-off procedure, which checks before transmitting on the ad hoc radio channel whether the latter is occupied.

The document “ETSI EN 302 663 V1.2.0 (2012-11),” which is incorporated by reference herein, describes the two lowermost layers of the ITS-G5 technology (ITS G5: Intelligent Transport Systems, which operate in the 5 GHz frequency band), the physical layer and the data security layer. Radio modules C1, C2, C3 implement, for example, these two lowermost layers and corresponding functions according to “ETSI TS 102 687 V1.1.1 (2011-07)” in order to use the ad hoc radio channel. The following non-licensed frequency bands are available in Europe for the use of the ad hoc radio channel, which is part of the non-licensed frequency band NLFB: 1) ITS-G5A for safety-relevant applications in the frequency range 5.875 GHz through 5.905 GHz; 2) ITS-G5B for non-safety-relevant applications in the frequency band 5.855 GHz through 5.875 GHz; and 3) ITS-G5D for the operation of ITS applications in the frequency range 5.055 GHz through 5.925 GHz. ITS-G5 enables the communication between control units NN1, NN2, NN3 outside the context of a base station. The Standard ITS-G5 enables the immediate exchange of data frames and avoids the effort that is required in the construction of a cell-based network.

The document “ETSI TS 102 687 V1.1.1 (2011-07),” which is incorporated by reference herein, describes for ITS-G5 a “Decentralized Congestion Control Mechanism.” The ad hoc radio channel is used, among other things, for exchanging traffic safety data and traffic efficiency data. Radio modules C1, C2, C3 implement, for example, the functions as they are described in the document “ETSI TS 102 687 V1.1.1 (2011-07).” The applications and services of ITS-G5 are based on the cooperative behavior of control units NN1, NN2, NN3, which form radio communication network 2. Radio communication network 2 enables time-critical applications in road traffic, which require a rapid exchange of information in order to alert and to support the driver and/or the vehicle in a timely manner. In order to ensure the smooth functioning of radio communication network 2, “Decentral Congestion Control” (DCC) is used for the ad hoc radio channel by ITS-G5. DCC has functions that are located on multiple layers of the ITS architecture. The DCC mechanisms are based on knowledge about the radio channel. The channel state information is obtained via channel probing.

In the traffic situation shown, vehicle V1 is traveling ahead of vehicle V2 and vehicle V2 is traveling ahead of vehicle V3. Vehicles V1 through V3 form a line, a so-called platoon. Motor vehicles V2 and V3 separately adapt their respective distance to preceding motor vehicle V1 and V2 in order to be able to carry out an emergency brake application without rear-ending the preceding motor vehicle.

In the example shown, a respectively signed control message Ni, N2, N3 by control unit NN1, NN2, NN3 is sent to control unit NN2, NN3 of the immediately following motor vehicle, control unit NN2, NN3 checking the origin of the control message based on a contained signature. In one refinement, an encryption of control message N1, N2, N3 is provided, for example, including a group key, so that the motor vehicles of the group have access to control message N1, N2, N3.

Motor vehicle V2 is designed to maintain a distance dv12 to preceding motor vehicle V1. Distance dv12 is made up of a first distance dm12 and a second distance ds12. First distance dm12 takes into account uncertainties in the behavior of the two motor vehicles V1, V2 such as, for example, different braking distances of motor vehicles V1 and V2, uncertainties in sensor measured data such as, for example, a measured distance with the aid of a radar sensor. Second distance ds12, which is also referred to as an additional safety distance, is determined by motor vehicle V2 and is explained in greater detail in the following. The aforementioned statements may also be applied to distances dv23, dm23 and ds23.

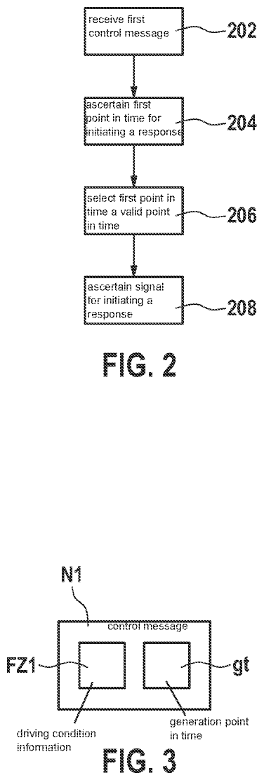

FIG. 2 schematically shows a sequence diagram for operating control unit NN2 of motor vehicle V2 from FIG. 1. In a step 202, the method includes receiving a first control message, which includes at least one piece of driving condition information, originating from on-board control unit NN1 of motor vehicle V1. The method includes in a step 204 ascertaining a first point in time for initiating the response of motor vehicle V2 as a function of the first control message. The method includes in a step 206 selecting the first point in time as a valid point in time. In a step 208, the method includes ascertaining a signal for initiating the response of motor vehicle V2 if, up to the valid point in time, no further control message originating from on-board control unit NN1 is successfully received. Invariably only one single valid point in time per control unit is present, which is updated by the aforementioned selection. Control unit NN2 initiates the response, of course, in particular an emergency brake application, even regardless of the absence of the control messages if this is explicitly signaled to it or the host sensor system indicates the response, in particular a brake application, in particular an emergency brake application.

FIG. 3 shows by way of example the structure of control message N1, the other control messages N2, N3 being similarly constructed. Control message N1 includes at least one piece of driving condition information FZ1 such as, for example, a setpoint velocity or a setpoint acceleration, the driving condition information FZ1 relating to motor vehicle V1 or to motor vehicle V2 and represents an actual variable or a setpoint variable. Control message N1 also includes a generation point in time gt of control message N1. Alternatively, control message N1 includes no generation point in time.

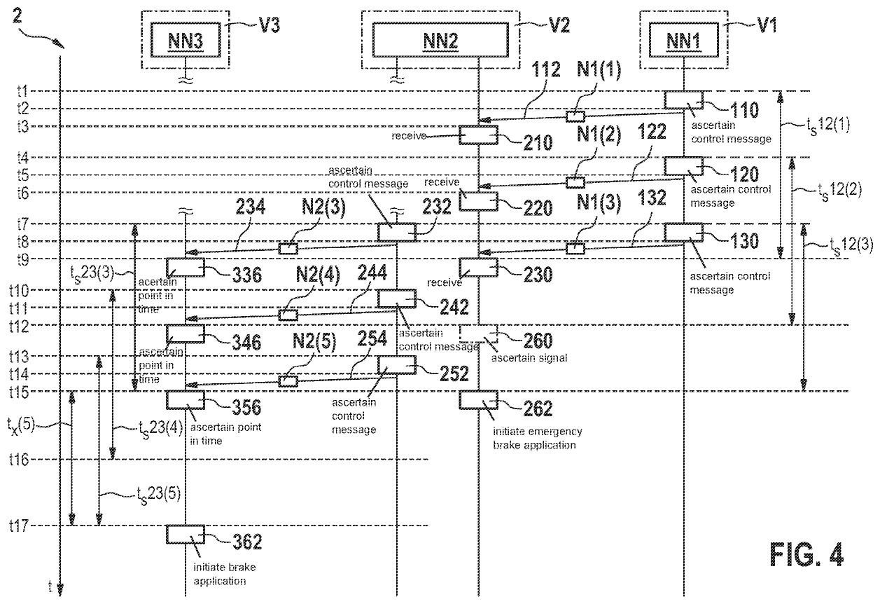

FIG. 4 schematically shows a sequence diagram for operating a group of control units NN1, NN2, NN3 of radio communication network 2. The points in time represented coincide in part for reasons of clarity and may, of course, be separated. In particular, a shared time basis, i.e., a temporal synchronization of control units NN1, NN2, NN3, need not necessarily be present. In addition, the following example is related to the initiation of a brake application as a response to the absence of control messages. The example shown may, of course, also be applied to other responses of respective motor vehicle V2, V3 such as, for example, to the reduction of the engine power.

At a point in time t1, t4, t7, on-board control unit NN1 ascertains in a step 110, 120, 130 control message N1(1), N1(2), N1(3), which is transferred to communication module C1 at a point in time t2, t5, t8 and is transmitted in a step 112, 122, 132 to control unit NN2. Control unit NN2 successfully receives (steps 210, 220, 230) control message N1(1), N1(2), N1(3) at a point in time t3, t6, t9, a processing time upon receipt being taken into account.

Starting from point in time t1, t4, t7, control unit NN2 ascertains a point in time t9, t12, t15 up to which at least one further control message originating from control unit NN1 should be received by control unit NN2. Point in time t9, t12, t15 is ascertained starting from generation point in time t1, t4, t7 and from a safety time period ts12(1), ts12(2), ts12(3). Safety time period ts12(1), ts12(2), ts12(3) is variable and is adapted to the driving situation or to the network situation. The determination of safety time period ts12(1), ts12(2), ts12(3) is explained in greater detail below. Points in time t9, t12, t15 are also identifiable as braking points in time.

Generation point in time t1, t4, t7 is estimated alternatively to its communication within respective control message N1(1), N1(2), N1(3), the time for sending the control message via the radio interface and a queuing delay starting from reception point in time t3, t6, t9 being taken into account. The term estimation is understood to mean the ascertainment of generation point in time t1, t4, t7, which ensures the safety in the platoon via a brake application. In addition, control unit NN1, NN2 sends a control message N1(1), N2(3) only when a time period between points in time t1, t2 or t7, t8 does not exceed a maximum time period. Assuming that control unit NN2, NN3 is able to ascertain the transfer time, for example, based on the modulation scheme and coding scheme used, control unit NN2, NN3 is able to determine a conservative estimate about the generation point in time by recalculating the reception point in time, taking the transfer time and the maximum time period into account. This presupposes that control unit NN1, NN2 does not send the control message, should the waiting time after generating the control message exceed the defined maximum time period, for example, due to an occupied radio channel.

If, up to the occurrence of point in time t12 ascertained in a step 220, no further control message originating from control unit NN1 of the immediately preceding motor vehicle were to be successfully received by control unit NN2, then control unit NN2 would ascertain in a virtual step 260—i.e., immediately following the occurrence of point in time t12—signal S2 from FIG. 1 for initiating an emergency brake application of motor vehicle V2, and would initiate an emergency brake application of motor vehicle V2. However, virtual step 260 is not carried out, since control message N1(3) is received still within the time window of safety time period ts12(2). Accordingly, point in time t15 is ascertained, which is selected as a valid point in time or as the valid braking point in time.

As a result of the periodic reception of control messages, the valid point in time is not reached during a normal operation. If the control messages are not successfully received, then the initiation of the response, in the present case a brake application of motor vehicle V2, takes place. Valid points in time are, for example, at points in time t9, t12, t15 in the case of control unit NN2. Valid points in time are, for example, at points in time t15, t16 and t17 in the case of control unit NN3.

Control message N1(3) is the last control message successfully received by control unit NN2. Point in time t15 ascertained in step 230 is thus the valid point in time. Upon reaching the valid point in time, an emergency brake application of motor vehicle V2 is initiated in step 262 with the aid of an ascertainment of signal S2 by control unit NN2.

In a step 232, 242, 252, second control unit NN2 ascertains control message N2(3), N2(4), N2(5) and transmits this message in a step 234, 244, 254 to control unit NN3. Control message N2(3), N2(4), N2(5) includes, for example, associated generation point in time t7, t10, t13 and is transferred to communication module C2 of control unit NN2 at point in time t8, t11, t14. Control unit NN3 ascertains reception point in time t9, t12, t15 for control message N2(3), N2(4), N2(5). In a step 336, 346, 356, third control unit NN3 ascertains point in time t15, t16, t17 and selects this as the valid point in time.

Control unit NN2 in one example prevents the further sending of control messages in the direction of control unit NN3 after valid point in time t15 has taken effect. This ensures that control unit NN3 ascertains in a step 362 signal S3 from FIG. 1 at valid point in time t17 and thus initiates a brake application, in particular an emergency brake application, of third motor vehicle V3.

Alternatively or in addition, at least one of control messages N2(4), N2(5) in one further example contains pieces of information about a response, in particular a brake application, initiated by control unit NN2. Control unit NN3 receives the information about the response initiated by control unit NN2 and also initiates the previously determined response. Since the safety time period is greater than the period duration of the control messages, an abrupt end of the stream of control messages may be detected at any time and the safety time period is sufficient for initiating a safe brake application of the respective motor vehicle.

The safety distance to respective preceding vehicle V1, V2 is ascertained and adapted as a function of ascertained safety period ts12, ts23. Additional safety distance ds12, ds23 explained in FIG. 1, which vehicle V2, V3 maintains to the preceding vehicle, results from ascertained safety period ts12, ts23. A time period tx(5) elapses between point in time t15 at which motor vehicle V2 initiates the response and point in time t17 at which motor vehicle V3 initiates the response. A distance traveled by third vehicle V3 within time period tx(5) is less than a distance traveled by third vehicle V3 within time period ts23(5). Thus, preventing the further sending of control messages originating from control unit NN2 to control unit NN3 is sufficient for carrying out a safe brake application within the group of control units, without a following motor vehicle rear-ending the motor vehicle following immediately ahead.

A driving situation is shown in FIG. 4, in which a response of the vehicle is the emergency brake application. In another situation, the group of motor vehicles travels, for example, through an expressway construction site. Here, the distances are so great that each motor vehicle is able to separately carry out an emergency brake application. In this case, the absence of control messages results initially in a reduction of the engine power.

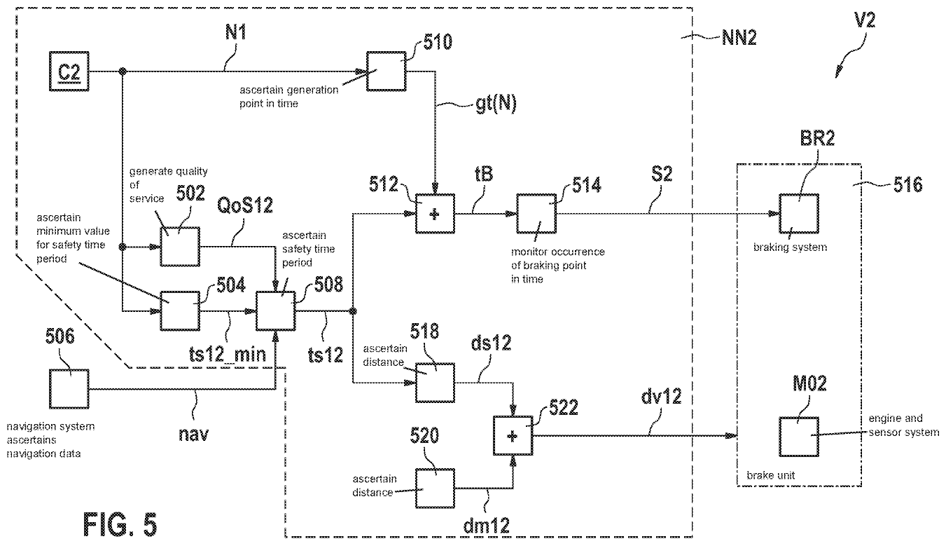

FIG. 5 schematically shows a block diagram of motor vehicle V2. Communication module C2 generates a stream of control messages N2. A block 502 generates a quality of service QoS12 as a function of control messages N2. Quality of service QoS12 is, for example, a numerical value and represents, for example, a number of control message losses per time unit. For example, block 502 expects a number of control messages within established time intervals. If this number of received control messages within one time interval falls short, then quality of service QoS12 also drops.

A block 504 ascertains a minimum value ts12 min for safety time period ts12, for example, as a function of control messages N2. Thus, for example, a period duration of the receipt of control messages N2 is ascertained and aforementioned minimum value ts12 min is established to be at least two period durations. A navigation system 506 situated outside network unit NN2 ascertains navigation data nav such as, for example, the instantaneous number of lanes of the road negotiated by vehicle V2, which indicates an occupancy of the radio channel used. A block 508 ascertains safety time period ts12 as a function of quality of service QoS12 as a function of minimum value ts12 min and as a function of navigation data nay.

A block 510 ascertains a generation point in time gt(N) of a respective control message of control messages N2. Generation point in time gt(N) is either contained in the respective control message N2 or alternatively is estimated, for example, as a function of the ascertained reception point in time. Starting from generation point in time gt(N), a block 512 ascertains braking point in time tB by adding safety time period ts12. Braking point in time tB is selected by a block 514 as the valid braking point in time and block 514 monitors an occurrence of braking point in time tB. Upon reaching the instantaneously valid braking point in time, block 514 generates signal S2, which prompts a braking system BR2 of a drive and brake unit 516 to carry out an emergency brake application of motor vehicle V2.

A block 518 ascertains distance ds12 as a function of the instantaneous velocity of vehicle V2 and as a function of safety time period ts12. A block 520 ascertains distance dm12. A block 522 ascertains distance dv12, for example, by adding dm12 and ds 12 and transmits this distance dv12 to drive and brake unit 516, which adjusts ascertained distance dv12 to preceding motor vehicle V1 with the aid of braking system BR2 and an engine MO2 and sensor system not shown.

The assignments of the individual blocks, for example, to control unit NN2 are exemplary and may, of course, be differently configured.

1-10. (canceled)

11. A first on-board control unit of a group of control units of a radio communication network and for a first motor vehicle, the first on-board control unit comprising:
at least one processor;
at least one memory including computer program code;
at least one communication module; and
at least one antenna;
wherein, the computer program code is configured to, including the at least one processor, the at least one communication module and the at least one antenna, cause the first on-board control unit to:
receive a first control message, which includes at least one piece of driving condition information, originating from a second on-board control unit of a second motor vehicle preceding the first motor vehicle,
ascertain a first point in time for initiating a response of the first motor vehicle as a function of the first control message,
select the first point in time as a valid point in time, and ascertain a signal for initiating a response of the first motor vehicle when, up to the valid point in time, no further control message originating from the second on-board control unit is successfully received.

12. The first on-board control unit as recited in claim 11, wherein the first on-board control unit is further configured to:
receive a second control message originating from the second on-board control unit of the second motor vehicle preceding the first motor vehicle temporally before the occurrence of the valid point in time;
ascertain a second point in time for initiating the response of the first motor vehicle as a function of the second control message, the second point in time lying further in the future compared to the valid point in time; and
select the second point in time as the valid point in time.

13. The first on-board control unit as recited in claim 11, wherein the first on-board control unit is further configure to:
ascertain a safety time period;
ascertain the first point in time as a function of the ascertained safety time period; and
adapts a safety distance between the first motor vehicle and the second motor vehicle as a function of the safety time period.

14. The first on-board control unit as recited in claim 13, wherein the first control message includes an indication for a generation point in time of the first control message, and the first control unit is configured to:
ascertain the first point in time as a function of the safety time period and as a function of the generation point in time of the first control message.

15. The first on-board control unit as recited in claim 13, wherein the first control unit is configured to:
estimate a generation point in time of the first control message as a function of a reception point in time of the first control message; and
ascertains the first point in time as a function of the safety time period and as a function of the estimated generation point in time of the first control message.

16. The first on-board control unit as recited in claim 13, wherein the first on-board control unit is configured to:
ascertain a quality of service (QoS) of the first control messages received from the second control unit; and
ascertain the safety time period as a function of the ascertained QoS.

17. The first on-board control unit as recited in claim 13, wherein the safety time period is greater than a period duration of a transmitting and/or receiving frequency of the first control message originating from the second control unit.

18. The first on-board control unit as recited in claim 13, wherein the first on-board control unit is configured to:
up to an occurrence of the valid point in time, send a further number of control messages, each of which includes at least one piece of driving condition information, in a direction of a third on-board control unit of a third motor vehicle; and
after the occurrence of the valid point in time, send no further control messages in the direction of the third on-board control unit.

19. A first motor vehicle, comprising:
a first on-board control unit including: at least one processor, at least one memory including computer program code, at least one communication module, and at least one antenna, wherein, the computer program code is configured to, including the at least one processor, the at least one communication module and the at least one antenna, cause the first on-board control unit to: receive a first control message, which includes at least one piece of driving condition information, originating from a second on-board control unit of a second motor vehicle preceding the first motor vehicle, ascertain a first point in time for initiating a response of the first motor vehicle as a function of the first control message, select the first point in time as a valid point in time, and ascertain a signal for initiating a response of the first motor vehicle when, up to the valid point in time, no further control message originating from the second on-board control unit is successfully received; and
a braking system,
wherein the first on-board control unit is configured to transmit the signal to the braking system for initiating a brake application of the first motor vehicle.

20. A method for operating a first on-board control unit for a first motor vehicle, the method comprising:
receiving a first control message, which includes at least one piece of driving condition information, originating from a second on-board control unit of a second motor vehicle preceding the first motor vehicle;
ascertaining a first point in time for initiating a response of the first motor vehicle as a function of the first control message;
selecting the first point in time as a valid point in time, and ascertaining a signal for initiating the response of the first motor vehicle when, up to the valid point in time, no further control message originating from the second on-board control unit is successfully received.
